(19) United States
(12) Patent Application Publication
(10) Pub. No.: US 2026/0302763 A1
(43) Pub. Date: Oct. 1, 2026

(54) EXTENDED VOLTAGE OPERATING RANGES OF POWER SUPPLIES

(71) Applicant: ITRON, INC., Liberty Lake, WA (US)

(72) Inventor: Brent Timothy MARTIN, Anderson, SC (US)

(21) Appl. No.: 19/097,074

(22) Filed: Apr. 1, 2025

(51) Int. Cl. H02H 7/125; H02H 1/04; H02H 3/06; H02H 3/08

(52) U.S. Cl. CPC H02H 7/125; H02H 1/043; H02H 3/066; H02H 3/083

(57) ABSTRACT

In various embodiments, a circuit for providing a power supply comprises a switching circuit configured to receive a voltage input, and a high voltage switching and current limit control circuit (HVSCC) that is configured to stop an in-rush current associated with a first rising edge of the voltage input from reaching the switching circuit when the in-rush current exceeds an overcurrent threshold, and prevent the switching circuit from resetting until at least a second rising edge on the voltage input.

### BACKGROUND

### Field of the Various Embodiments

The various embodiments relate generally to power supplies, and more specifically, to extended voltage operating ranges of power supplies.

### Description of the Related Art

Many meters and measurement devices have been deployed to perform meteorology when located at a wide range of sites. Typically, a meter is connected to a power source and includes a power supply for devices connected to or included in the meter. The meter then collects data regarding the power drawn and/or delivered to devices that are connected to the power supply. In many environments, the meter is configured to operate based on the amount of power transmitted by the power supply, where a given electronic meter includes a power supply that is rated based on the amount of power delivered by a power source. As sites connect more devices to the electrical grid, many power sources now transmit large amounts of power to address the needs of the devices on the electronic grid. Consequently, meters and on-site power supplies need to be configured to handle the large amounts of power delivered by power sources.

### BRIEF DESCRIPTION OF THE DRAWINGS

So that the manner in which the features of the various embodiments can be understood in detail, a particular description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a conceptual block diagram of a power supply configured to function over an extended operating range, according to various embodiments;

FIG. 2 illustrates a conceptual block diagram of an endpoint device that includes the power supply of FIG. 1, according to various embodiments;

FIG. 3 illustrates a schematic diagram of an example polyphase circuit that includes the high voltage switching and current limit control circuit of FIG. 1, according to various embodiments;

FIG. 4 illustrates a schematic diagram of an example single phase circuit that includes the high voltage switching and current limit control circuit of FIG. 1, according to various embodiments; and

FIG. 5 sets forth a flowchart of method steps for processing power from an alternating current source, according to the various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

Many electrical meters include or are connected to a power supply that requires a consistent power level at a constant voltage to operate effectively. At a given location, various devices are connected to a power supply that converts an alternating current (AC) input into a constant or pulsating direct current (DC) supply output. Devices that are connected to the power supply receive the DC supply output and the electrical meter acquires measurement data that reflects the amount of power drawn by the connected devices. For example, a power supply can receive an AC input, such as a single-phase AC input or a polyphase set of phase-shifted inputs, from a power source. The AC input can have a root-mean-square (RMS) average voltage of 120 V. The power supply converts the AC input into and produces a DC supply output that has an average voltage of 24 V with a maximum power of 15 W. One or more devices connected to the power supply draw power based on the reception of a consistent power delivered by the power supply.

During operation, when a given power supply is first turned on at high voltages or when the power supply receives a large surge of power, there can be a large rush of current (an “in-rush current”) associated with the large power input that is transmitted to the power supply. This in-rush current can exceed the current rating of one or more electronic components included in the power supply, damaging the power supply components and causing the power supply to fail in operation. In order to handle such large power inputs during a startup event, the power supply typically requires a specific “start” capacitor that possesses a large capacitance to absorb the additional power due to the in-rush current. However, such start capacitors often have low power ratings and are not always capable of handling large voltages. Thus, a high-voltage power supply, which handles large voltages after startup, also requires capacitors with high power ratings to handle large voltages received after the startup event. These high-voltage-rated capacitors, though, possess low capacitance values and are not capable of receiving all the power delivered via the AC input during normal operation. Consequently, many high-voltage power supplies require multiple high-voltage-rated capacitors (e.g., four to five high-voltage-rated capacitors connected in series) to handle the large power input associated with the large voltage that the power supply receives during normal operation. As a result, such a high-voltage-rated power supply includes a combination of a start capacitor and multiple high-voltage rated capacitors and thus occupy a large physical space, increasing the volume and price of high-voltage power supplies.

Some conventional techniques that are currently employed to design high-voltage power supplies include techniques to lower the number of high-voltage-rated capacitors needed to handle high-voltages. One technique comprises segmenting the operating range of a single power supply to multiple power supplies. Such segmentation narrows the operating range of a given power supply while covering a large operating range. For example, instead of implementing a power supply that is rated to operate for a large voltage range (e.g., 120 V-480 V AC root mean squared), conventional techniques deploy multiple power supplies, where each power supply is rated to operate over smaller range, such as a first power supply rated an operating range around 120 V (e.g., 120 V +/- 20%) and a second power supply rated for an operating range around 140 V (e.g., 140 V +/- 20%). Other techniques include using large switching devices, such as high-voltage-rated power field effect transistors (FETs), that are configured to handle the large in-rush current. However, the high-voltage-rated power FETs are larger than FETs rated for lower voltages and are more expensive to produce and include in circuits. Further, each of the conventional techniques outlined above limit the actual power that a given power supply can deliver or limit the operational input range of the power supply.

To address these deficiencies, a high-voltage power supply includes control circuitry that handles a large voltage operating range while reducing the volume and price of electric components included in the high-voltage power supply. The disclosed techniques control the current and power handled by the high voltage power supply in a manner that decreases the quantity of high-voltage-rated capacitors necessary to handle high voltage inputs and high current surges. A high-voltage power supply includes a high voltage switching and current limit control circuit (HVSCC) that controls the voltage that is delivered to a capacitor system that is charged with the power provided by the AC input. The power supply can be a polyphase circuit that is configured to receive a polyphase AC input and be rated for an operating voltage input range of 120-960 V AC root mean squared (rms). Alternatively, the power supply can include a single phase circuit that is configured to receive a single-phase AC input and have an operating voltage input range of 120-480 V AC rms. The HVSCC is connected to a capacitor system. The capacitor system that includes a low-voltage-rated capacitor (in both the polyphase and the single phase circuits) and one or more high-voltage-rated capacitors (in the polyphase circuit). The HVSCC is also connected to a high-power switching circuit that includes multiple transistors, such as a set of stacked power MOSFET switches. The high-voltage switching circuit is a type of cascode amplifier (e.g., a cascode follower) that operates at high frequencies. The HVSCC of the polyphase circuit also includes a voltage-setting circuit that imposes a maximum voltage that is delivered to the high-voltage switching circuit and the capacitor system.

The HSVCC controls the maximum in-rush current that is supplied from the power line to the high-power switching circuit and the capacitor system. The HSVCC includes a latch that trips above a threshold current, turning off one or more switches in the high-power switching circuit. The HSVCC thus controls the high-power switching circuit during an overcurrent condition, such as during the first rising edge of a voltage input that occurs during startup event or during a power surge event. The latch also avoids a thermal runaway event in the high-voltage power supply that otherwise would occur due to the switching circuit resetting. The HSVCC avoids the thermal runaway event by keeping at least one of the switches included in the high-voltage switching circuit off until the AC input reaches zero voltage and a subsequent rising edge in the voltage input occurs. Thereafter, the switching circuit resets and is able to turn back on when the voltage input reaches the applicable voltage threshold. In such instances, the voltages across each device in the high-voltage switching circuit are at the minimum level required to turn on each switch included in the high-voltage switching circuit. Delaying the high-voltage switching circuit from restarting in this manner ensures that the voltage input returns to a safe operating condition before the high-voltage switching circuit is able to reset.

At least one technical advantage of the disclosed techniques is that the disclosed techniques increase the operating range of a power supply. In particular, the disclosed techniques enable a power supply to handle the respective large currents and large voltages that the power supply receives during operation without requiring the power supply to include a large quantity of high-current-rated capacitors and high-power-rated capacitors. In particular, the inclusion of a high voltage switching and current limit control circuit protects a switching circuit that controls the delivery of a voltage input to one or more charging capacitors and ensures that the switching circuit does not prematurely reset during overcurrent conditions. In this manner, the power supply can handle a large voltage operating range using switches and capacitors that are rated for lower voltages without damaging the switches and capacitors during overcurrent conditions. Selection of switches and capacitors rated for lower voltages for inclusion in the power supply results in components that occupy smaller physical volumes. As a result, such a power supply reduces the space that the power supply occupies in a device and reduces the price of components required to build a power supply rated to operate over large voltage ranges.

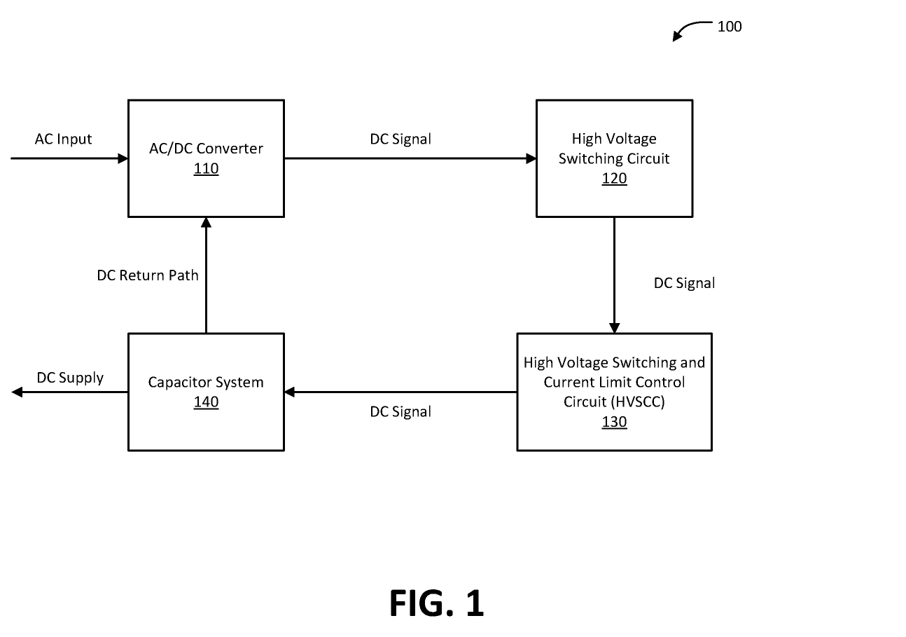

FIG. 1 illustrates a conceptual block diagram of a power supply 100 configured to function over an extended operating range, according to various embodiments. As shown, the power supply 100 includes, without limitation, an alternating current/direct current (AC/DC) converter 110, a high voltage switching circuit 120, a high voltage switching and current limit control circuit (HVSCC) 130, and a capacitor system 140.

In operation, the AC/DC converter 110 receives an AC input from a power source. The AC/DC converter 110 outputs a high voltage DC signal to the high voltage switching circuit 120. The high voltage switching circuit 120 regulates the flow of the high voltage DC signal. The HVSCC 130 controls the flow of power from the high voltage switching circuit 120 to the capacitor system 140. The capacitor system receives the DC output of the high voltage switching circuit 120 via the HVSCC 130 and charges one or more capacitors. The capacitor system 140 periodically discharges one or more capacitors included in the capacitor system 140 to transmit a DC supply output to one or more devices connected to the power supply 100. The capacitor system 140 can also transmit a DC return path to the AC/DC converter.

In various embodiments, the AC/DC converter 110 includes one or more circuits that are configured to process an AC input and generate a DC output. In some embodiments, the AC/DC converter 110 includes multiple stages. In such instances, the AC/DC converter 110 can include a rectifier stage and one or more filter stages. The rectifier stage and the filter stage(s) can be arranged in any order. For example, the AC/DC converter 110 can include a Pi filter that initially removes noise from the AC input; a half-wave rectifier or a full-wave rectifier can then receive a filtered AC signal from the Pi filter and convert the filtered AC signal to a DC signal. In some embodiments, the type of rectifier included in the AC/DC converter 110 can be based on the type of AC input the power supply is expected to receive. For example, when the AC/DC converter 110 is included in a single-phase circuit that is configured to receive a single-phase AC input, the AC/DC converter 110 can include a half-wave rectifier circuit that generates a pulsating DC output. In another example, when the AC/DC converter 110 is included in a polyphase circuit that is configured to receive a polyphase AC input, the AC/DC converter 110 can include a full-wave rectifier circuit that generates a pulsating DC output.

In various embodiments, the high voltage switching circuit 120 includes one or more switches that control the flow of the DC signal that is transmitted from the AC/DC converter 110. In various embodiments, the high voltage switching circuit 120 includes one or more power transistors, such as one or more power field-effect transistors (FETs). In such instances, the one or more power FETs are high-voltage-rated FETs that are rated to receive a maximum current and/or voltage associated with the DC signal produced by the AC/DC converter 110. In some embodiments, the high voltage switching circuit 120 can include two or more power transistors that control the flow of the DC signal to the capacitor system 140. For example, the high voltage switching circuit 120 can include two power metal-oxide semiconductor field-effect transistors (MOSFETs) that are connected in a cascode follower configuration. In such instances, the high voltage switching circuit 120 allows the DC signal to flow from the AC/DC converter 110 to the capacitor system 140 via the high voltage switching circuit 120 when each switch is closed.

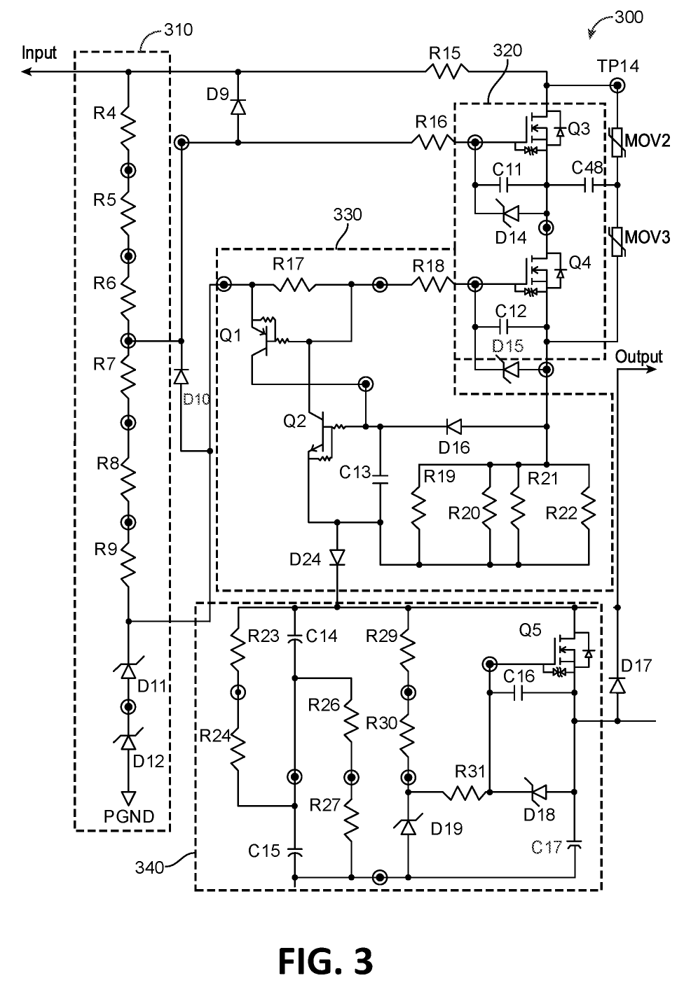

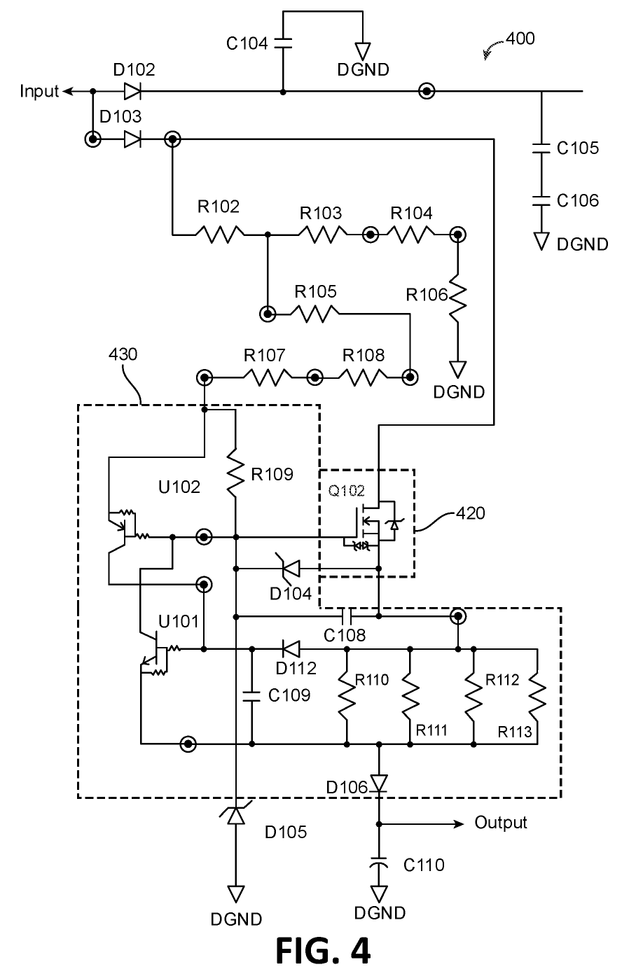

As will be discussed further in relation to FIGS. 3 and 4, the operation of the HVSCC 130 limits the current that flows through the high voltage switching circuit 120. As a result, the one or more switches included in the high voltage switching circuit 120 can be rated for lower currents than the maximum current that the AC/DC converter 110 outputs. For example, the AC/DC converter 110 can, during startup events and/or during power surge events, transmit a DC signal that includes a current of approximately 20 A. In such instances, the HVSCC 130 can limit the current of the DC signal, limiting the flow through the high voltage switching circuit 120 upon reaching a overcurrent threshold (e.g., a threshold of 4 A). Accordingly, the high voltage switching circuit 120 can include low-current-rated FETs (e.g., FETs rated to handle currents up to a maximum of 4 A) in lieu of high-current-rated FETs (e.g., FETs rated to handle currents up to 20 A). In various embodiments, the overcurrent threshold can be set based on the current rating of the switches in the high voltage switching circuit 120; the actual overcurrent threshold can be higher or lower than 4 A.

In various embodiments, the HVSCC 130 is a switch control stage of the power supply 100 that acts as a current limiter for the high voltage switching circuit 120 and/or the capacitor system 140. In such instances, the HVSCC 130 limits the maximum current that flows through the high voltage switching circuit 120 and/or the capacitor system 140 during startup events and/or during power surge events. Restricting the current thereby lowers the level of current in the DC signal that reaches the switches in the high voltage switching circuit 120 and/or the capacitors in the capacitor system 140. For example, as will be discussed in further detail in FIGS. 3 and 4, the HVSCC 130 can include sub-components, such as a resistor network and an analog latch. As the DC signal from the AC/DC converter 110 flows through closed switches included in the high voltage switching circuit 120 to the HVSCC 130, the voltage of the resistor network rises. When the current does not reach an overcurrent threshold, the voltage of the resistor circuit does not reach a threshold level (indicating the high current). In such instances, the HVSCC 130 does not detect an overcurrent condition and the included analog latch does not trigger, allowing the DC signal to flow through the high voltage switching circuit 120 for an entire charging period, charging the capacitor system 140. In contrast, when the capacitor system 140 reaches a charge threshold, the high voltage switching circuit 120 can then turn off for the remainder of the charging period (e.g., until the next falling edge of the DC signal).

Alternatively, when the current of the DC input reaches the overcurrent threshold, the resistor network reaches the corresponding threshold voltage and triggers at least one switch in the analog latch to turn on. The HVSCC 130 detects the overcurrent condition when the analog latch triggers. The triggering of the analog latch in the HVSCC 130 turns off at least one of the switches included in the high voltage switching circuit 120 for the remainder of a charging cycle, restricting the DC input from flowing to the capacitor system 140. In such instances, keeping the high voltage switching circuit 120 off for the remainder of the charging cycle prevents the high voltage switching circuit 120 from resetting prematurely and causing a thermal runaway event from occurring. As the AC input lowers below zero voltage, the voltage of DC signal produced by the AC/DC converter 110 also lowers towards zero voltage. The lower voltage of the DC signal corresponds to a safe voltage for the high voltage switching circuit 120 to handle. The HVSCC 130 is then able to reset at the next rising edge of the AC signal (e.g., during a subsequent charging period). The high voltage switching circuit 120 resets and is able to turn on during the subsequent charging period when a voltage threshold (determined by the voltage on the capacitors in the capacitor system 140) is exceeded by the DC signal. Due to the HVSCC 130 limiting the current that flows through the high voltage switching circuit 120 and/or the capacitor system 140, the power supply 100 is more robust and resilient against damage or destruction due to overcurrent conditions.

In various embodiments, the capacitor system 140 includes one or more capacitors that are charged using the DC signal produced by the AC/DC converter 110 and are discharged to one or more connected devices. In various embodiments, the capacitor system 140 periodically charges and discharges, providing a constant or pulsating DC supply output to one or more connected devices (not shown). For example, the high voltage DC output of the AC/DC converter 110 can periodically be transmitted to the capacitor system 140 and charge the capacitors. In various embodiments, the high voltage switching circuit 120 can periodically switch on and off in a manner where the capacitor system 140 is charged to a threshold level during a charging period and discharged during a discharging period in a manner where the capacitor system 140 provides a DC supply output to the next stage of the power supply 100, where the next stage of the power supply 100 outputs a supply signal at a voltage of 24 V with a maximum power output of 15 W. In some embodiments, the capacitor system 140 includes a set of one or more capacitors that charge and discharge when the current stays below an overcurrent threshold. Additionally, or alternatively, in some embodiments, the capacitor system 140 can include a set of one or more capacitors that charge during overcurrent conditions, such as during a startup event. In such instances, the set of capacitors designed for such overcurrent conditions can be connected in series to receive a maximum amount of voltage. For example, two high-voltage capacitors rated for a maximum of 450 V can be connected in series to receive a total of 900 V during overcurrent conditions. In some embodiments, the HVSCC 130 controls the current that flows to the series of high-voltage-rated capacitors; alternatively, in some embodiments, the HVSCC 130 is not connected to the series of high-voltage-rated capacitors. For example, as will be discussed in further detail in relation to FIG. 4, the series of high-voltage-rated capacitors can directly handle the maximum voltage of a DC input that is generated in a single-phase circuit. Consequently, the HVSCC 130 does not need to control the maximum voltage that is delivered to the series of high-voltage-rated capacitors, instead, the HVSCC 120 prevents an overcurrent condition.

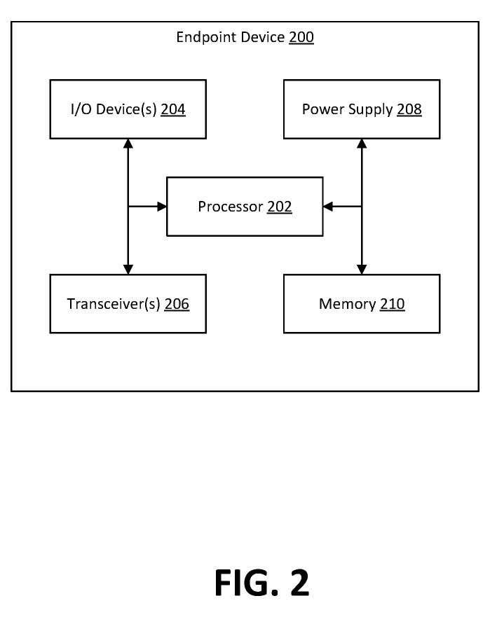

FIG. 2 is a conceptual diagram of an endpoint device 200 that includes a power supply configured to function over an extended operating range, according to various embodiments. As shown, the endpoint device 200 includes, without limitation, a processor 202, one or more input/output devices 204, one or more transceivers 206, and a power supply 208.

The endpoint device 200 can be any device that receives power from a power source and transmits the power to one or more other devices or components in the endpoint device 200. In some embodiments, the endpoint device 200 is a device that communicates with devices in a network (not shown). In one example, the endpoint device 200 is a utility metering device that is coupled to, or included within, a utility distribution infrastructure in which the endpoint device 200 monitors consumption of a utility commodity (e.g., water, gas, electricity, steam, etc.). In other embodiments, the endpoint device 200 is a smart streetlight. In still other embodiments, the endpoint device 200 is a demand control device, such as a shut-off switch for a pool pump, an air conditioning unit, and/or the like.

In various embodiments, the endpoint device 200 is one device in a large deployment of endpoint devices 100 to a region. For example, the endpoint devices 100 can be in a deployment of thousands of endpoint devices 100 in a geographic region that are connected to the utility distribution infrastructure. In such instances, the utility distribution infrastructure can experience a grid disruption, such as a blackout, a brown out, etc. When a grid disruption occurs, the power source restarts, causing a potential in-rush current to the endpoint device 200 and/or the power supply 208 included in the endpoint device 200. Additionally, or alternatively, the in-rush current can be due to a surge in the grid. The power supply 208 included in the endpoint device 200 can be configured to handle in-rush currents associated with such grid disruptions and/or grid surges.

The processor 202 coordinates the operations of endpoint device 200. In various embodiments, the processor 202 includes any hardware configured to process data and execute software applications. The processor 202 can be any technically feasible processing device configured to process data and execute program instructions. For example, the processor 202 can include one or more central processing units (CPUs), DSPs, graphics processing units (GPUs), application-specific integrated circuits (ASICs), field-programmable gate arrays (FPGAs), microprocessors, microcontrollers, other types of processing units, and/or a combination of different processing units. The processor 202 can include a real-time clock (RTC) (not shown) according to which the processor 202 maintains an estimate of the current time. The estimate of the current time can be expressed in Universal Coordinated Time (UTC), although any other standard of time measurement can also be used.

The one or more I/O devices 204 include devices configured to receive input, devices configured to provide output, and devices configured to both receive input and provide output. As described above, in some examples, the endpoint device 200 is a utility metering device that is coupled to, or included within, a utility distribution infrastructure. In this example, the one or more I/O devices 204 can further include one or more data acquisition devices that are used by endpoint device 200 to monitor consumption of a utility commodity (e.g., water, gas, electricity, etc.). For example, the one or more I/O devices 204 can further include one or more of an electricity meter, a gas meter, a water meter, or some other type of sensor used to monitor consumption of a utility commodity.

The one or more transceivers 206 are configured to establish one or more communications channels and transmit messages to and/or receive messages from other devices in the network (e.g., one or more neighboring endpoint devices, an access point in a network, a back office, etc.). The one or more transceivers 206 can be implemented as any suitable transmission and/or reception device. In some embodiments, the one or more transceivers 206 include a plurality of antennas in an antenna array. For example, the antenna array can be a phased array that generates a steerable directional radiation pattern in a specific direction. In some examples, the one or more transceivers 206 can operate in a first communication mode in which the one or more transceivers 206 communicate with one or more devices in a first type of network and can operate in a second communication mode in which the one or more transceivers 206 communicate with one or more devices in a second type of network. For example, while in the first communication mode, transceiver 206 establishes a first communications channel and transmits messages to and/or receives messages from devices in a first type of network (e.g., Cat-M1 network) via a first type of access point. As another example, while in the second communication mode, transceiver 206 establishes a second communication channel and transmits messages to and/or receives messages from devices in a second type of network (e.g., NB-IoT network) via a second type of access point. In operation, the one or more transceivers 206 can transition between communication modes. In some examples, the one or more transceivers 206 can operate in more than two communication modes and/or communicate with devices in more than two different types of networks. The memory 210 can include any technically feasible storage device, such as a random-access memory (RAM) module, a flash memory unit, a hard disk drive, non-volatile storage, or any other type of memory unit or combination thereof.

The power supply 208 provides power to one or more of the components included in endpoint device 200. For example, the power supply 208 powers one or more of the processor 202, the I/O devices 204, the transceivers 206, and the memory 210. In some examples, the power supply 208 is connected to mains-power such that the power supply 208 powers one or more components of endpoint device 200 with mains-power. In various examples, the power supply 208 converts the mains-power to another type of power and transmits the converted power to one or more connected devices. For example, the power supply 208 can receive mains-power as an AC input and can output a constant or pulsating DC output to one or more devices connected to the endpoint device 200.

### Extended Voltage Operating Range of Power Supplies

FIG. 3 illustrates a schematic diagram of an example polyphase circuit 300 that includes the high voltage switching and current limit control circuit 130 of FIG. 1, according to various embodiments. As shown, the polyphase circuit 300 includes, without limitation, a voltage-setting stage 310, a high voltage switching circuit 320, a high voltage switching and current limit control circuit (HVSCC) 330, and a capacitor system 340.

In various embodiments, the polyphase circuit 300 is rated to operate over a wide voltage range. The polyphase circuit is configured to receive a polyphase AC signal, which comprises a plurality of phase-shifted AC signals. The polyphase circuit 300 also includes a set of components that are rated to operate over a narrower voltage range. For example, the polyphase circuit 300 has an operating range of a 120-960 V AC input (rms) and is configured to handle surges up to 1340 V. The polyphase circuit 300 also includes one or more components that are rated to operate for lower voltages and/or lower currents; the inclusion of the HVSCC 330 limits the current that flows through the polyphase circuit 300, thus allowing components with lower current ratings be included. Due to using electrical and electronic components with lower current ratings, the polyphase circuit 300 can be approximately 20% smaller than conventional designs that operate over the same 120-960 V operating range.

In operation, the polyphase circuit 300 receives an input power from an AC/DC converter (not shown). During regular charging and discharging, the input power can have a large voltage (e.g., up to 960 V). During overcurrent conditions, the voltage can spike up to higher levels (e.g., up to approximately 1340 V). When the HVSCC 330 detects an over current condition, the analog latch comprising the transistors Q1 and Q2 turns on, causing the transistor (e.g., the power switch Q4) included in the high voltage switching circuit 320 to turn off, stopping current from flowing to the capacitor system 340. The HVSCC 330 causes Q4 to remain off for the remainder of the charging cycle, preventing the large current from flowing through the high voltage switching circuit 320 or the capacitor system 340. The capacitor system 340 discharges when the high voltage switching circuit 120 is disconnected. Upon the HVSCC 330 resetting, the high voltage switching circuit 320 is able to reset and turn on during a subsequent charging period once the AC input reaches a voltage threshold that is set by the voltage capacity of the capacitors C14-C15 and/or C17.

In various embodiments, the voltage-setting stage 310 comprises a voltage-setting circuit or device that sets a voltage limit that the capacitor system 340 receives and sets the voltage of the high voltage switching circuit 320. As shown, the maximum voltage that is received by the gates of the FET Q4 is equal to the combined voltage of the series of diodes in the switching circuit (e.g., D11 and D12). For example, when D11 and D12 are 350 V diodes, the maximum voltage of the gate for Q4 is 700 V. In various embodiments, the selection of the diodes in the high voltage switching circuit 320 can be based on the voltage capacity of the capacitor system 340.

The capacitor system 340 includes a set of high-voltage-rated capacitors C14 and C15 connected in series and another capacitor C17 connected in parallel. In various embodiments, the capacitors C14 and C15 are connected to withstand a high voltage. For example, C14 and C15 can be rated for a maximum of 450 V; when connected in series, the combination of capacitors is capable of withstanding up to a maximum of 900 V. Further, the combination of capacitors C14 and C15 have a lower capacitance due to being connected in series. For example, C14 and C15 can respectively have a capacitance of 120 µF. Due to being connected in series, the combination of capacitors has a combined capacitance of 60 µF. In various embodiments, the capacitor C17 can have a higher capacitance than the combined capacitance of C14 and C15. For example, C17 can also have a capacitance of 120 µF. In such instances, C17 charges for lower voltages while the combination of C14 and C15 charge for higher voltages.

During a charging period, the DC signal is received as an input. The first rising edge of a voltage input corresponds to the beginning of the charging period; a second rising edge of the voltage input corresponds to a second charging period, etc. The high voltage switching circuit 320 is on, where Q3 and Q4 are closed, allowing current to flow through the HVSCC 330 to the capacitor system 340. When flowing through the HVSCC 330, the current generates a voltage in the resistor network (R19-R22). When the current of the DC signal generates a corresponding threshold voltage in the resistor network, the analog latch (e.g., Q1 and Q2) triggers, where each of the switches included in the analog latch turns on. The triggering of the analog latch causes the Q4 switch to turn off (e.g., where Q4 is open) and turn off the high voltage switching circuit 320. Turning off the high voltage switching circuit 320 cuts the flow of current through the HSVCC 330 to the capacitor system 340.

Due to the stoppage of current flow to the HSVCC 330, the voltage of the resistor network also lowers. In such instances, the high voltage switching circuit 320 may attempt to reset and may cause a potential thermal runaway event due to the Q3 and Q4 switches attempting to close and restart the flow of current. Turning the Q3 and Q4 switches back on while having the high voltage across the switches may violate the safe operating area of the switches, causing the switches to fail and causing the power supply 300 to enter a thermal runaway event. However, the analog latch of the HVSCC 330 prevents the high voltage switching circuit 320 from restarting and possibly entering a runaway event. For example, due to the characteristics of the analog latch, the initial triggering of Q1 and Q2 causes Q1 to remain on, even as the voltage in the resistor network drops and turns Q2 off. As a result, Q1 of the analog latch causes Q4 to remain off as the voltage of the DC signal lowers. In such instances, Q1 remains on until the voltage of the DC signal approaches 0 V, causing the high voltage switching circuit 320 to remain off at least until the voltage of the DC signal is at a minimum level, preventing Q3 and Q4 from damage due to high voltage.

During a discharging period, the AC input goes negative, causing the DC signal to decrease. Subsequent to this discharging period, a second rising edge of the voltage input occurs and the HVSCC 330 resets. When the HVSCC 330 resets, the voltage in the HVSCC 330 discharges through the diodes D10, D9 and a resistive path (not shown).

In various embodiments, one or more of the capacitors C14, C15 and/or C17 discharge when the high voltage switching circuit 320 is disconnected. When discharging, the one or more of the capacitors C14, C15 and/or C17 discharge through the output, providing a DC supply output into the 24 V section (e.g., a stage to convert the DC supply output to a 24 V DC output) with a maximum power of 15 W. In various embodiments, the polyphase circuit 300 cycles through the charging and discharging period between 60-120 per second. In such instances, high voltage switching circuit 320, the HVSCC 330, and/or the capacitor system 340 can reset between 60-120 times per second.

FIG. 4 illustrates a schematic diagram of an example single phase circuit 400 that includes the high voltage switching and current limit control circuit 130 of FIG. 1, according to various embodiments. As shown, the single phase circuit 400 includes, without limitation, a high voltage switching circuit 420, a high voltage switching and current limit control circuit 430, a protected capacitor C110 and a series of high voltage capacitors C105 and C106.

In various embodiments, the single phase circuit 400 is rated to operate over a narrower voltage range than the polyphase circuit 300. The single phase circuit 400 also includes a set of components that are rated to operate over the narrower voltage range and can be in a different configuration than the configuration of the polyphase circuit 300. For example, the single phase circuit 400 is configured to operate over a 120-480 V AC input range (rms), with surges up to 670 V. The surge voltage of 670 V remains lower than the combined voltage capacity of the series of high voltage capacitors C105 and C106, which can individually have a voltage capacity of 350 V and a combined voltage capacity of 700 V. Consequently, the series of high voltage capacitors C105 and C106 can directly receive the high voltage during overcurrent conditions and does not need the protection of the HVSCC 430. The single phase circuit 400 includes one or more components that are rated to operate for lower voltages and/or lower currents, such as the FET Q102 included in the high voltage switching circuit 420 and/or the protected capacitor C110. The inclusion of the HVSCC 430 limits the current that flows through the high voltage switching circuit 420 and the protected capacitor C110, thus allowing components with lower current ratings be included. Due to using electrical and electronic components with lower current ratings, the single phase circuit 400 can be approximately 10-20% smaller than conventional designs that operate over the same 120-480 V operating range.

In operation, the single phase circuit 400 receives an input power from an AC/DC converter (not shown). During overcurrent conditions, the voltage can spike up to high voltage levels (e.g., up to approximately 670 V). When the HVSCC 430 detects an over current condition, the analog latch comprising the transistors U101 and U202 turns on, causing the transistor Q102 that comprises the high voltage switching circuit 420 to turn off, stopping current of the DC signal from flowing to the protected capacitor C110. The HVSCC 430 causes Q102 to remain off for the remainder of the charging cycle, preventing any large current of the DC signal from flowing through the high voltage switching circuit 420 or the protected capacitor C110. Once the charging period ends, the protected capacitor system C110 discharges and the HVSCC 430 resets, enabling the high voltage switching circuit 420 to reset for a subsequent charging period.

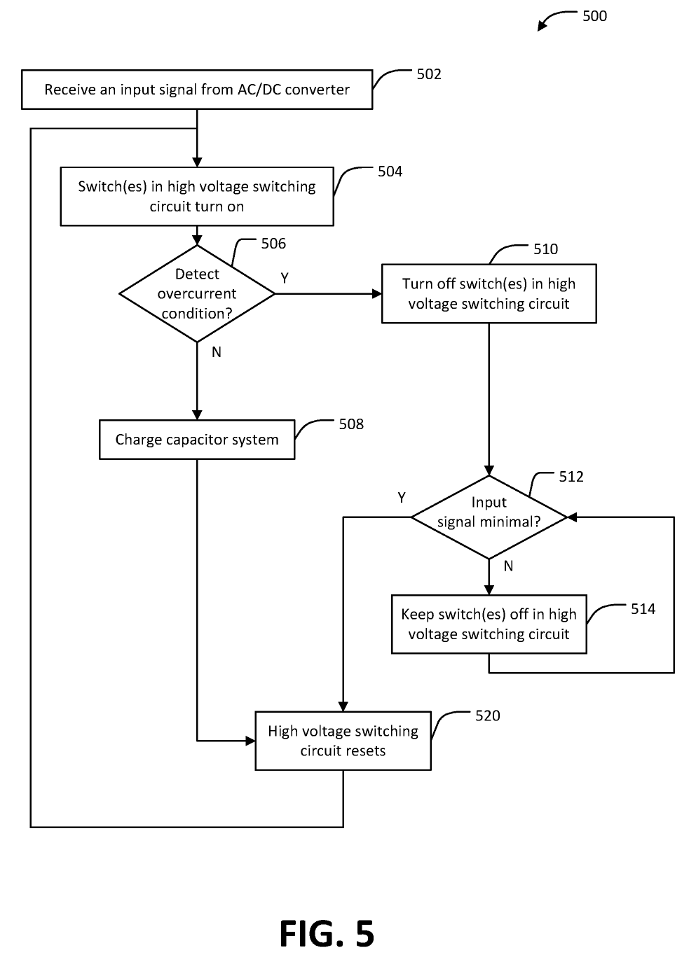

FIG. 5 sets forth a flowchart of method steps for processing power from an alternating current source, according to the various embodiments. Although the method steps are shown in an order, persons skilled in the art will understand that some method steps may be performed in a different order, repeated, omitted, and/or performed by components other than those described in FIG. 5. Although the method steps are described with respect to the systems of FIGS. 1-4, persons skilled in the art will understand that any system configured to perform the method steps, in any order, falls within the scope of the various embodiments.

As shown, a method 500 begins at step 502, where the power supply 100 receives an input signal from the AC/DC converter 110. In various embodiments, the power supply 100 receives an AC input signal from a power source and the AC/DC converter 110 included in the power supply 100 converts the AC input signal to a DC signal. In some embodiments, the AC/DC converter 110 includes a rectifier stage and one or more filter stages. In such instances, the AC/DC converter 110 produces a DC signal that is filtered to reduce noise included in the AC input signal. In some embodiments, the AC input signal comprises a polyphase signal. In such instances, the power supply 100 includes a polyphase circuit 300 to produce a DC output signal. Alternatively, in some embodiments, the AC input signal comprises a single phase AC signal. In such instances, the power supply 100 includes a single phase circuit 400 to produce a DC output signal.

At step 504, the one or more switches in the high voltage switching circuit turn on. In various embodiments, one or more switches included in the high voltage switching circuit 120 turn on, closing the switches and allowing current to flow to the capacitor system 140. For example, the plurality of switches Q3 and Q4 that are included in the high voltage switching circuit 320 turns on when the voltage of the DC signal exceeds a threshold voltage, closing the switches and allowing the DC input from the AC/DC converter 110 to flow through the HVSCC 330 to and charge the capacitors C14, C15, and/or C17 included in the capacitor system 340.

At step 506, the HVSCC 130 determines whether an overcurrent condition is occurring. In various embodiments, the HVSCC 130 is triggered when the power supply 100 receives an in-rush current that corresponds to an overcurrent condition. The overcurrent condition can comprise a large initial current associated with events, such as the startup of the power supply 100 or the power source, a power surge, and/or other conditions associated with a spike in power and/or current. The in-rush current raises the voltage of a resistor network included in the HVSCC 130 (e.g., the resistor network R19-R22 included in the HVSCC 330). When the in-rush current rises above an overcurrent threshold, the voltage of the resistor network surpasses a voltage threshold and triggers the analog latch (e.g., Q1 and Q2 of the HVSCC 330) to turn on. When the HVSCC 130 detects the overcurrent condition, the power supply 100 proceeds to step 510. Otherwise, the HVSCC 130 does not detect the overcurrent condition and the power supply 100 proceeds to step 508.

At step 508, the capacitor system 140 is charged with the input signal. In various embodiments, the HVSCC 130 does not detect an overcurrent condition associated with an in-rush current. In such instances, the analog latch included in the HVSCC 130 does not trigger and the high voltage switching circuit 120 remains on, allowing current to flow through the HVSCC 130 to the capacitor system 140. During the charging period, the DC input from the AC/DC converter 110 flows to the capacitor system 140 and charges one or more capacitors. The capacitors initially act as a dead short, initially stopping current flow. As the capacitors charge, the circuit allows more current to flow through the circuit.

At step 510, the HVSCC 130 turns off one or more switches included in the high voltage switching circuit 120. In various embodiments, the HVSCC 130 triggers in response to the in-rush current. The HVSCC 130 controls at least one switch included in the high voltage switching circuit 120 and limits the current that can flow through the high voltage switching circuit 120. For example, the analog latch of the HVSCC 330 controls at least the switch Q4 in the high voltage switching circuit 320. When the analog latch of the HVSCC 330 triggers, the HVSCC 330 turns Q4 off, opening the switch and stopping the current of the DC signal from flowing through the high voltage switching circuit 320 to the capacitor system 340. In this manner, the HVSCC 330 prevents a high current from flowing through the high voltage switching circuit 320 and damaging components in the high voltage switching circuit 320 and/or the capacitor system 340.

At steps 512, the HVSCC 130 determines whether the input voltage has reached a minimal voltage. In various embodiments, the stoppage of current flow through the high voltage switching circuit 120 stops current flow to the HVSCC 130. Consequently, the voltage of the resistor network also lowers. In such instances, the high voltage switching circuit 120 may attempt to reset and may cause a potential thermal runaway event due to the switches attempting to close and cause a high voltage to reach the switches. Such a thermal runaway event is vastly higher than the voltage rating of the switches and can cause damage to the switches. However, the analog latch of the HVSCC 130 prevents the high voltage switching circuit 120 from entering a runaway event. For example, the initial triggering of Q1 and Q2 in the HVSCC 330 causes Q1 to remain on, even as the voltage in the resistor network drops and turns Q2 off. As a result, Q1 of the analog latch causes Q4 of the high voltage switching circuit 120 to remain off as the voltage lowers. In such instances, the analog latch of the HVSCC 330 remains on until the AC input is a negative voltage and the DC signal produced by the AC/DC converter 110 is minimal. When the HVSCC 130 detects that the DC signal at a minimal voltage, the power supply 100 proceeds to step 520. Otherwise, the HVSCC 130 does not detect that the DC signal has reached the minimal voltage and the power supply proceeds to step 512.

At step 514, the HVSCC 130 keeps the one or more switches in the high voltage switching circuit 120 off. In various embodiments, the analog latch included in the HVSCC 130 remains on as the voltage input decreases. In such instances, the analog latch remaining on and causes the high voltage switching circuit 120 to remain off until the voltage of the voltage input is at a minimum level. For example, Q1 of the HVSCC 330 remains on and keeps the high voltage switching circuit 320 off until a subsequent rising edge of the voltage input. Upon keeping the high voltage switching circuit 120 off, the HVSCC 130 returns to step 512 to determine whether the DC signal has reached zero voltage.

At step 520, the high voltage switching circuit 120 resets. In various embodiments, upon the input signal reaching zero voltage, the DC signal subsequent reaches a subsequent rising edge and the HVSCC 130 resets. Upon the HVSCC 130 resetting, the high voltage switching circuit 120 is also able to reset. In such instances, the switches in the high voltage switching circuit 120 can close and allow current to flow through the high voltage switching circuit 120 during the subsequent charging period. Upon resetting the HVSCC 130, the power supply can return to step 504 to turn on the high voltage switching circuit 120 and allow the DC signal to charge the capacitor system 140.

In sum, techniques disclosed are herein for providing a power supply over a wide input operating voltage. According to various embodiments, a power supply includes a high voltage switching circuit, a high voltage switching and current limit control circuit, and a capacitor system. The high switching control circuit limits the maximum current that flows through the high voltage switching circuit and the capacitor system. During a charging period, an input signal flows through the high voltage switching circuit and capacitors in the capacitor system. During an overcurrent condition, the high voltage switching and current limit control circuit detects a high current in the input signal and turns the high voltage switching circuit off, causing the high voltage switching circuit to disconnect, which stops the input signal from flowing to the capacitor system. The high voltage switching and current limit control circuit causes the high voltage switching circuit to remain off as the voltage in the input signal lowers, preventing the high voltage switching circuit from resetting prematurely and triggering a thermal runaway event. The capacitor system discharges when the high voltage switching circuit is disconnected, providing a constant direct current supply signal to one or more connected devices. Upon a subsequent rising edge of the input signal, the high voltage switching and current limit control circuit and enables the high voltage switching circuit to reset, enabling the capacitor system to charging during the subsequent charging period.

At least one technical advantage of the disclosed techniques relative to the prior art is that the disclosed techniques increase the operating range of a power supply. In particular, the disclosed techniques enable a power supply to handle the respective large currents and large voltages that the power supply receives during operation without requiring the power supply include a large quantity high-current-rated capacitors and of high-power-rated capacitors. In particular, the inclusion of a high voltage switching and current limit control circuit protects the switching circuit that controls the delivery of a DC output and ensures that the switching circuit does not prematurely reset during overcurrent conditions. In this manner, the power supply can handle a large voltage operating range with switches and capacitors rated for lower voltages without damaging the switches and capacitors during overcurrent conditions. Selection of switches and capacitors rated for lower voltages occupies smaller physical volumes, reducing the space that the power supply occupies in a device and reduces the price of components required to build a power supply rated to operate over large voltage ranges. These technical advantages provide one or more technological advancements over prior art approaches.
1. In various embodiments, a circuit for providing a power supply comprises a switching circuit configured to receive a voltage input, and a high voltage switching and current limit control circuit (HVSCC) that is configured to stop an in-rush current associated with a first rising edge of the voltage input from reaching the switching circuit when the in-rush current exceeds an overcurrent threshold, and prevent the switching circuit from resetting until at least a second rising edge on the voltage input.
2. The circuit of clause 1, where the in-rush current comprises one of a startup event or a surge event.
3. The circuit of clause 1 or 2, where the HVSCC is included in a polyphase circuit and the voltage input comprises a plurality of phase-shifted alternating current (AC) inputs.
4. The circuit of any of clauses 1-3, where the polyphase circuit is configured to receive an input voltage between 120 V and 960 V.
5. The circuit of any of clauses 1-4, where the polyphase circuit further comprises a voltage-setting circuit connected to the switching circuit.
6. The circuit of any of clauses 1-5, where the polyphase circuit further comprises a capacitor system that includes a series of one or more high-voltage-rated capacitors, and a series of one or more low-voltage-rated capacitors.
7. The circuit of any of clauses 1-6, where the HVSCC is included in a single phase circuit and the voltage input comprises a single alternating current (AC) input.
8. The circuit of any of clauses 1-7, where the single phase circuit is configured to receive an input voltage between 120 V and 480 V.
9. The circuit of any of clauses 1-8, where the single phase circuit includes a capacitor system that includes at least one low-voltage-rated capacitor.
10. The circuit of any of clauses 1-9, where the switching circuit comprises a cascode amplifier.
11. In various embodiments, a method comprises receiving, by a power supply, a first current of a power input, disconnecting, by a control circuit included in the power supply, at least one power switch included in the power supply when a first rising edge of the power input exceeds a threshold, and preventing, by the control circuit, the at least one power switch from resetting until a subsequent rising edge of the power input.
12. The method of clause 11, further comprising converting, by the power supply, the first current to a direct current or a pulsating current, where the first current comprises an alternating current.
13. The method of clause 11 or 12, where an analog latch included in the control circuit disconnects the at least one power switch.
14. The method of any of clauses 11-13, where the at least one power switch comprises a high voltage rated power field effect transistor (FET).
15. The method of any of clauses 11-14, where the at least one power switch resets between 60 and 120 times per second.
16. The method of any of clauses 11-15, where the control circuit is included in a polyphase circuit and the power input comprises a plurality of phase-shifted alternating current (AC) inputs that provide a voltage between 120 V and 960 V.
17. The method of any of clauses 11-16, where the control circuit is included in a single phase circuit and the power input provides an alternating current (AC) voltage between 120 V and 480 V.
18. In various embodiments, a meter device includes a circuit configured to deliver a supply voltage, the power supply circuit comprising a plurality of switches configured to receive an alternating current (AC) voltage input and outputs the supply voltage, and a switch control stage connected to the plurality of switches that is configured to stop the AC voltage input from reaching the plurality of switches in response to an overcurrent condition associated with a first rising edge of the AC voltage input occurring, and prevent the plurality of switches from resetting after the overcurrent condition until a second rising edge of the AC voltage input occurs.
19. The meter device of clause 18, where the switch control stage is included in a polyphase circuit and the AC voltage input comprises a plurality of phase-shifted AC inputs that provide a voltage between 120 V and 960 V.
20. The meter device of clause 18, where the switch control stage is included in a single phase circuit and the pulsating voltage input provides a voltage between 120 V and 480 V.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A circuit for providing a power supply, the circuit comprising:
a switching circuit configured to receive a voltage input; and
a high voltage switching and current limit control circuit (HVSCC) that is configured to:
stop an in-rush current associated with a first rising edge of the voltage input from reaching the switching circuit when the in-rush current exceeds an overcurrent threshold; and
prevent the switching circuit from resetting until at least a second rising edge on the voltage input.

2. The circuit of claim 1, wherein the in-rush current comprises one of a startup event or a surge event.

3. The circuit of claim 1, wherein the HVSCC is included in a polyphase circuit and the voltage input comprises a plurality of phase-shifted alternating current (AC) inputs.

4. The circuit of claim 3, wherein the polyphase circuit is configured to receive an input voltage between 120 V and 960 V.

5. The circuit of claim 3, wherein the polyphase circuit further comprises a voltage-setting circuit connected to the switching circuit.

6. The circuit of claim 3, wherein the polyphase circuit further comprises a capacitor system that includes:
a series of one or more high-voltage-rated capacitors; and
a series of one or more low-voltage-rated capacitors.

7. The circuit of claim 1, wherein the HVSCC is included in a single phase circuit and the voltage input comprises a single alternating current (AC) input.

8. The circuit of claim 7, wherein the single phase circuit is configured to receive an input voltage between 120 V and 480 V.

9. The circuit of claim 7, wherein the single phase circuit includes a capacitor system that includes at least one low-voltage-rated capacitor.

10. The circuit of claim 1, wherein the switching circuit comprises a cascode amplifier.

11. A method comprising:
receiving, by a power supply, a first current of a power input;
disconnecting, by a control circuit included in the power supply, at least one power switch included in the power supply when a first rising edge of the power input exceeds a threshold; and
preventing, by the control circuit, the at least one power switch from resetting until a subsequent rising edge of the power input.

12. The method of claim 11, further comprising:
converting, by the power supply, the first current to a direct current or a pulsating current, wherein the first current comprises an alternating current.

13. The method of claim 11, wherein an analog latch included in the control circuit disconnects the at least one power switch.

14. The method of claim 11, wherein the at least one power switch comprises a high voltage rated power field effect transistor (FET).

15. The method of claim 11, wherein the at least one power switch resets between 60 and 120 times per second.

16. The method of claim 11, wherein the control circuit is included in a polyphase circuit and the power input comprises a plurality of phase-shifted alternating current (AC) inputs that provide a voltage between 120 V and 960 V.

17. The method of claim 11, wherein the control circuit is included in a single phase circuit and the power input provides an alternating current (AC) voltage between 120 V and 480 V.

18. A meter device including:
a circuit configured to deliver a supply voltage, the power supply circuit comprising:
a plurality of switches configured to receive an alternating current (AC) voltage input and outputs the supply voltage; and
a switch control stage connected to the plurality of switches that is configured to:
stop the AC voltage input from reaching the plurality of switches in response to an overcurrent condition associated with a first rising edge of the AC voltage input occurring; and
prevent the plurality of switches from resetting after the overcurrent condition until a second rising edge of the AC voltage input occurs.

19. The meter device of claim 18, wherein the switch control stage is included in a polyphase circuit and the AC voltage input comprises a plurality of phase-shifted AC inputs that provide a voltage between 120 V and 960 V.

20. The meter device of claim 18, wherein the switch control stage is included in a single phase circuit and the pulsating voltage input provides a voltage between 120 V and 480 V.
